(19) United States
(12) Patent Application Publication
(10) Pub. No.: US 2026/0154229 A1
(43) Pub. Date: Jun. 4, 2026

(54) TRANSMISSION SIGNAL EVALUATION MODULE FOR A TRANSMITTING/RECEIVING DEVICE OF A SUBSCRIBER STATION OF A SERIAL BUS SYSTEM, AND METHOD FOR TRANSMITTING A MESSAGE WITH DIFFERENTIAL SIGNALS IN A SERIAL BUS SYSTEM

(71) Applicant: Robert Bosch GmbH, Stuttgart (DE)

(72) Inventors: Olaf Kleinwegen, Pliezhausen (DE); Steffen Walker, Reutlingen (DE)

(21) Appl. No.: 19/126,489

(22) PCT Filed: Nov. 16, 2023
(86) PCT No.: PCT/EP2023/081996

§ 371 Date: May 1, 2025

(30) Foreign Application Priority Data
Jan. 11, 2023 (DE) 10 2023 200 155.1

(51) Int. Cl. G06F 13/42

(52) U.S. Cl. CPC G06F 13/4291

(57) ABSTRACT

A transmission signal evaluation module of a transmitting/receiving device of a subscriber station. The transmission module is configured to transmit a digital transmission signal as an analog differential signal on a bus of the bus system to transmit a message to at least one other subscriber station of the bus system. The transmission signal evaluation module has an MICI block for decoding a first transmission signal generated by a communication controller of the subscriber station, and for generating, from the first transmission signal, a decoded transmission signal and a mode of operation switch signal, with which the transmission module is to be signaled to switch to predetermined operating modes for communication phases, to detect the analog differential signal for the bus, a delay block, and a synchronization block for generating the digital transmission signal for the transmission module from the decoded transmission signal and the delayed transmission signal.

### FIELD

The present invention relates to a transmission signal evaluation module for a transmitting/receiving device of a subscriber station of a serial bus system and to a method for transmitting a message with differential signals in a serial bus system, which is in particular a CAN XL bus system.

### BACKGROUND INFORMATION

Serial bus systems are used, for example, to transmit messages or data in technical systems. A serial bus system, which in particular is a CAN bus system, may enable communication between sensors and control devices in a vehicle or technical production plant, etc.

In a CAN bus system, messages are transmitted using the CAN and/or CAN FD protocol as described in the ISO 11898-1:2015 standard as a CAN protocol specification with CAN FD. In CAN FD, the transmission on the bus switches back and forth between a slow operating mode in a first communication phase (arbitration phase) and a fast operating mode in a second communication phase (data phase). For example, CAN FD is used by most manufacturers with a 500 kbit/s arbitration bit rate and a 2 Mbit/s data bit rate in the vehicle.

Successor bus systems for CAN FD, such as CAN-SIC and CAN XL, are compatible with CAN FD and designed for even greater data rates in the second communication phase. In the case of CAN SIC according to the CiA601-4 standard of the CAN in Automation (CiA) organization, a data rate of about 5 to 8 Mbit/s is achieved in the second communication phase. In the case of CAN XL according to the CiA601-3 standard, a data rate in the second communication phase of >10 Mbit/s is required.

In the CAN XL, CAN FD and CAN SIC bus systems, the data are thus transmitted to the bus at a higher data rate in the second communication phase than in the first communication phase. For this purpose, in CAN XL, a bit of a transmission signal in the second communication phase not only has a shorter bit duration or bit time or time length than in the first communication phase but is usually also to be transmitted to the bus with a different physical layer and received with a different receive threshold than in the first communication phase. Accordingly, in CAN XL, the bus levels of the CAN_H, CAN_L bus signals for the first communication phase may be different from the bus levels of the second communication phase. In CAN XL, the type of communication in the second communication phase is also called FAST MODE. The physical layer corresponds to the bit transmission layer or layer 1 of the conventional OSI (Open Systems Interconnection) model.

Therefore, the most error-free communication possible on the bus may only take place if CAN XL subscriber stations of the bus system use a transmitting/receiving device that detects and implements the switching between the two communication phases in a message to be transmitted to the bus or to be received from the bus in the most error-free manner possible and implements the level of a transmission signal correctly for the bus. The transmitting/receiving device may also be referred to as a CAN transceiver or CAN FD transceiver, etc.

For this purpose, in a CAN XL subscriber station, a CAN controller transmits information to a transmitting/receiving device about the change of the communication phase and thus the operating mode to be switched on for the transmitting/receiving device. According to the CAN XL standard, the information is included in a type of data encoding that the CAN controller uses in a signal transmitted to the transmitting/receiving device. Here, it is defined that the CAN controller uses an NRZ encoding (NRZ=Non-Return to Zero) in the first communication phase (FAST MODE) and uses a pulse width modulation (PWM encoding) in the second communication phase (FAST MODE). The CAN controller must indicate the change from NRZ encoding to PWM encoding by two successive edges of the same polarity within a period of 205 ns.

If the transmitting/receiving device detects this information, the transmitting/receiving device switches from the previous slow operating mode (SLOW mode) to the operating mode for the FAST MODE. If the two consecutive edges of the same polarity are two rising edges, the transmitting/receiving device is to be switched to a Fast-TX operating mode in which the transmitting/receiving device in the FAST-MODE may transmit signals to the bus. If, however, the two consecutive edges of the same polarity are two falling edges, the transmitting/receiving device is to be switched to a Fast-RX operating mode in which the transmitting/receiving device in the FAST mode may only receive signals from the bus but cannot transmit them. Once the PWM encoding according to CiA610-3 transitions to an NRZ encoding, i.e., two consecutive edges of the same direction are no longer received in a predetermined time window, the system switches back to the slow operating mode (SLOW mode) so that the transmission signal TxD of the CAN controller is again translated into the recessive or dominant bus voltage.

The problem is that when transitioning from slow operating mode (SLOW mode) to fast operating mode (FAST-MODE) on the bus, a (n) (incomplete) transition Ul from dominant to recessive to dominant forms, as shown in FIG. 23. In addition, to detect the two consecutive edges of the same polarity, a certain number of clock cycles is required before it is possible to switch from the slow operating mode (SLOW mode) to the fast operating mode (FAST-MODE). As a result, a second (incomplete) transition U2 from dominant to recessive to dominant may form on the bus, as shown in FIG. 23.

The (incomplete) transitions U1, U2 from dominant to recessive to dominant generate undesirable signals on the bus, as they may be interpreted as errors by other subscriber stations of the bus system. This may result in a cancellation of the frame currently transmitted on the bus, thereby decreasing the net data rate on the bus.

Therefore, a transmitting/receiving device (transceiver) for CAN XL is required that ensures the most error-free communication possible for all operating phases of communication on the bus.

### SUMMARY

It is an object of the present invention to provide a transmission signal evaluation module for a subscriber station of a serial bus system and a method for transmitting a message with differential signals in a serial bus system that solve the aforementioned problems. In particular, a transmission signal evaluation module for a subscriber station of a serial bus system and a method for transmitting a message with differential signals in a serial bus system should enable the creation/generation of bus signals in the most simple manner possible, reliably and error-free if possible, even if the physical layer is switched between two communication phases during communication on the bus.

The object may be achieved by a transmission signal evaluation module for a transmitting/receiving device of a subscriber station of a serial bus system with certain features of the present invention. According to an example embodiment of the present invention, in the bus system, a transmission module is designed to transmit a digital transmission signal as an analog differential signal to a bus of the bus system in order to transmit a message to at least one other subscriber station of the bus system, wherein bits of the digital transmission signal have a greater bit duration in a first communication phase than in a second communication phase of the transmission signal. The transmission signal evaluation module has an MICI block for decoding a first transmission signal generated by a communication controller of the subscriber station and for generating, from the first transmission signal, a decoded transmission signal and an operating mode switch signal, with which a switching to predetermined operating modes for the communication phases is to be signaled to the transmission module, in order to generate the analog differential signal for the bus, a delay block for generating a delayed transmission signal from the first transmission signal, and a synchronization block for generating the digital transmission signal for the transmission module from the decoded transmission signal and the delayed transmission signal.

The described transmission signal evaluation module of the present invention is configured such that reliable and uncomplicated detection of bus signals takes place during operation of the bus system. All of this also applies in particular to such communication in which the physical layer of the transmitting/receiving device of the subscriber station is to be switched between two communication phases for communication on the bus.

In addition, the described transmission signal evaluation module of the present invention may very reliably extract information from a transmission signal and pass it on to the transmission module and/or the receiver module of the transmitting/receiving device on how to select or set the operating mode for the transmission module and/or the receiver module. Thus, it is possible to properly switch between two communication phases within a message for communication on the bus.

In this respect, the transmission signal evaluation module of the present invention described herein ensures a very low-failure and therefore as far as possible error-free communication, in particular in accordance with the standard CiA610-3 of CAN XL, between subscriber stations of the bus system. Additional advantages are explained in more detail in the description of the figures.

In addition, the transmission signal evaluation module of the present invention described herein is configured in such a way, And the transmission signal evaluation module described also allows the functionality of using different receive thresholds for the arbitration and data phase. This not only enables communication in the bus system between other subscriber stations with higher bit rates, but also ensures that the transmittable bit rate is not reduced by errors in the communication.

Advantageous further configurations of the transmission signal evaluation module are disclosed herein.

The delay block may comprise a delay sequence of delay cells forming replicas of delay cells of an oscillator module associated with the MICI block for clocking decoding of the MICI block. In this case, the delayed transmission signal may be delayed by a predetermined number of cycles of a clock of the oscillator module as compared to the first transmission signal.

The synchronization block may have a first edge detector for detecting falling edges of the first transmission signal, a second edge detector for detecting falling edges of the delayed transmission signal, a third edge detector for detecting rising edges of the delayed transmission signal, and a logic circuit for generating the digital transmission signal for the transmission module on the basis of the signals output by the edge detectors. In this case, the synchronization block may also have a D-flip flop for generating the digital transmission signal for the transmission module based on the signals output by the edge detectors.

According to an example embodiment of the present invention, it is possible that the MICI block is configured for decoding a temporarily NRZ-encoded first transmission signal and for decoding pulse-width modulated symbols of the temporarily pulse-width modulated first transmission signal.

According to one particular example embodiment of the present invention, the MICI block is arranged for decoding the message in the first communication phase and for decoding the message in the second communication phase.

According to one particular example embodiment of the present invention, the MICI block is configured for decoding signals for three different operating modes of the transmission module in the first transmission signal, wherein the MICI block is configured for generating the operating mode switch signal based on the decoding such that the transmission module is signaled to use a first operating mode (SLOW; SIC) for the first communication phase, to use a second operating mode if the subscriber station is to act as a transmitter in the second communication phase, and to use a third operating mode if the subscriber station is to act as a receiver in the second communication phase.

The transmission signal evaluation module of the present invention described above may be part of a transmitting/receiving device that also has a transmission module for transmitting a digital transmission signal as an analog differential signal on a bus of the bus system, in order to send a message to at least one other subscriber station of the bus system, and also has a receiver module for receiving signals from the bus and generating a digital receive signal from the analog differential signal.

According to one embodiment example of the present invention, the MICI block is arranged for decoding the first transmission signal in the first communication phase and decoding the first transmission signal in the second communication phase.

According to an example embodiment of the present invention, the transmission module may be configured for generating the analog differential signals with a different physical layer in the first communication phase of the message than in the second communication phase.

According to an example embodiment of the present invention, the above-described transmitting/receiving device may be part of a subscriber station for a serial bus system. The subscriber station may also be a communication controller for controlling the communication in the bus system and for generating the first transmission signal.

The subscriber station may optionally be configured for communication in a bus system in which exclusive, collision-free access of a subscriber station to the bus of the bus system is ensured at least temporarily.

The aforementioned object is also achieved by a method for transmitting a message with differential signals in a serial bus system with certain features of the present invention. According to an example embodiment of the present invention, the method is carried out with a transmitting/receiving device comprising a transmission module and a transmission signal evaluation module, which comprises an MICI block, a delay block and a synchronization block, wherein the method comprises the steps of using the MICI block for decoding a first transmission signal generated by a communication controller of the subscriber station for the message, in which bits in a first communication phase of the message have a greater bit duration than in a second communication phase of the message, for using the MICI block to generate from the first transmission signal, a decoded transmission signal and a mode of operation switch signal, with which the transmission module is signaled to switch to predetermined operating modes for two different communication phases, for generating the analog differential signal for the bus, for using the delay block to generate a delayed transmission signal from the first transmission signal, for using the synchronization block in order to generate a digital transmission signal for the transmission module from the decoded transmission signal and the delayed transmission signal, and for using the transmission module that is switched to the predetermined operating mode signaled with the operating mode switching signal to transmit the digital transmission signal as an analog differential signal on a bus of the bus system, in order to transmit the message to at least one other subscriber station of the bus system.

The method of the present invention offers the same advantages as those mentioned above with reference to the transmission signal evaluation module of the present invention.

Other possible implementations of the present invention also include not explicitly mentioned combinations of features or embodiments of the present invention described above or in the following with respect to the embodiment examples. In view of the disclosure herein, a person skilled in the art will also add individual aspects as improvements or additions to the respective basic form of the present invention.

### BRIEF DESCRIPTION OF THE DRAWINGS

The present invention is described in more detail in the following with reference to the figures and on the basis of embodiment examples.

FIG. 1 shows a simplified block diagram of a bus system according to a first embodiment example of the present invention.

FIG. 2 shows a diagram for illustrating the structure of a message that may be transmitted from subscriber stations of the bus system according to the first embodiment example of the present invention.

FIG. 3 shows an example of the ideal time profile of CAN_H, CAN_L bus signals, which are transmitted from subscriber stations of the bus system for the message of FIG. 2 to a bus of the bus system.

FIG. 4 shows the time profile of a differential voltage VDIFF that forms on the bus of the bus system as a result of the bus signals of FIG. 3.

FIG. 5 shows a block diagram of a transmitting/receiving device for a subscriber station of the bus system according to the first embodiment example of the present invention.

FIG. 6 shows a block diagram of a portion of the transmitting/receiving device of FIG. 5.

FIG. 7 to FIG. 16 show signal profiles over time for a communication phase in the bus system in which the operating mode of the transmitting/receiving device of FIG. 5 is switched from the slow operating mode to the fast operating mode.

FIG. 17 shows the time profile of the CAN_H, CAN_L bus signals, which are transmitted from the subscriber station of the bus system to the bus of the bus system as a consequence of the signals of FIG. 7 to FIG. 16.

FIG. 18 to FIG. 22 show signal profiles over time for a communication phase in the bus system in which the operating mode of the transmitting/receiving device is switched from the slow operating mode to the fast operating mode, but a transmission signal evaluation module of the transmitting/receiving device of FIG. 5 is operated solely and only for one data phase of a CAN CL message.

FIG. 23 shows the time profile of the CAN_H, CAN_L bus signals, which are transmitted by the subscriber station of the bus system to the bus of the bus system as a consequence of the signals of FIG. 18 to FIG. 22.

In the figures, the same or functionally similar elements are provided with the same reference signs unless stated otherwise.

### DETAILED DESCRIPTION OF EXAMPLE EMBODIMENTS

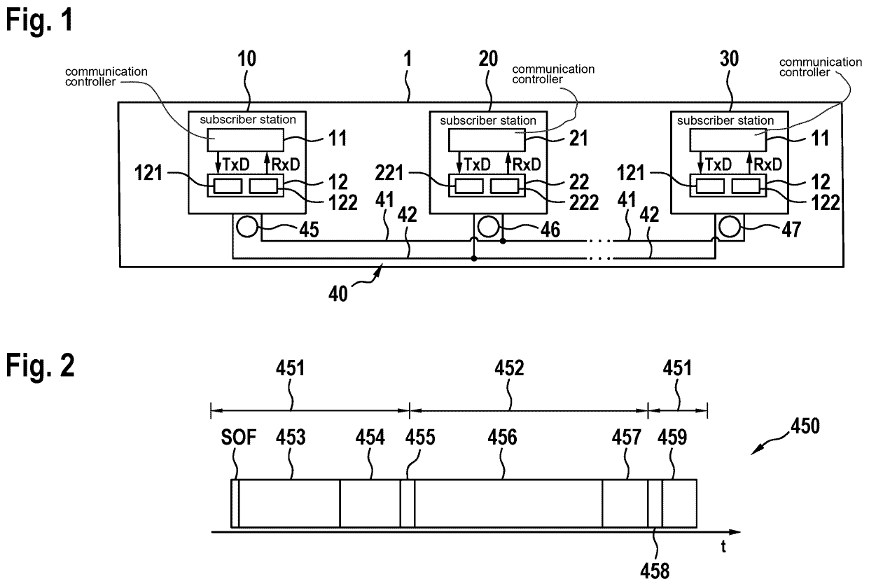

FIG. 1 shows a bus system 1 that can, for instance, at least partly be a CAN bus system, a CAN FD bus system, etc. The bus system 1 may be used in a vehicle, in particular a motor vehicle, an aircraft, etc., or in a hospital, etc.

The bus system 1 in FIG. 1 comprises a plurality of subscriber stations 10, 20, 30 that are all connected to a bus 40 or bus line with a first bus wire 41 and a second bus wire 42. The bus wires 41, 42 may also be referred to as CAN_H and CAN_L for the signals on the bus 40. Messages 45, 46, 47 in the form of signals may be transmitted between the individual subscriber stations 10, 20, 30 via the bus 40. The subscriber stations 10, 20, 30 are, for example, control devices or display devices of a motor vehicle.

As shown in FIG. 1, the subscriber stations 10, 30 each have a communication controller 11 and a transmitting/receiving device 12. The transmitting/receiving device 12 comprises a transmission module 121 and a receiver module 122.

The subscriber station 20 comprises a communication controller 21 and a transmitting/receiving device 22. The transmitting/receiving device 22 comprises a transmission module 221 and a receiver module 222.

The transmitting/receiving devices 12 of the subscriber stations 10, 30 and the transmitting/receiving device 22 of the subscriber station 20 are each connected directly to the bus 40, even if this is not shown in FIG. 1.

The communication controllers 11, 21 are respectively used to control communication of the respective subscriber station 10, 20, 30 via the bus 40 with at least one other subscriber station of the subscriber stations 10, 20, 30 that are connected to the bus 40.

The communication controller 11 creates and reads first messages 45, 47, which are, for example, modified CAN messages 45, 47. The structure of the modified CAN messages 45, 47 is based on the CAN XL format, for example. The transmitting/receiving device 12 is used to transmit and receive the messages 45, 47 from the bus 40. The transmission module 121 receives a digital transmission signal TxD created by the communication controller 11 for one of the messages 45, 47 and converts it into signals on the bus 40. The digital transmission signal TxD may be a pulse-width-modulated signal at least temporarily or in sections. The reception module 122 receives signals, transmitted on the bus 40, according to the messages 45 to 47 and generates therefrom a digital receive signal RxD. The receiver module 122 transmits the receive signal RxD to the communication controller 11.

In addition, the communication controller 11 may be configured to create and read second messages 46, which are, for example, CAN SIC messages 46. The transmitting/receiving device 12 may be designed accordingly.

The communication controller 21 may be configured like a conventional CAN controller according to ISO 11898-1:2015, i.e., like a CAN FD-tolerant traditional CAN controller or a CAN FD controller or a CAN SIC controller. The communication controller 21 creates and reads second messages 46, for example CAN SIC messages. The transmitting/receiving device 22 is used to transmit and receive the messages 46 from the bus 40. The transmission module 221 receives a digital transmission signal TxD created by the communication controller 21 and converts it into signals for a message 46 on the bus 40. The reception module 222 receives signals, transmitted on the bus 40, according to the messages 45 to 47 and generates therefrom a digital receive signal RxD. The transmitting/receiving device 22 may be designed as a conventional CAN SIC transceiver.

For transmitting the messages 45, 46, 47 with CAN SIC or CAN XL, proven properties that are responsible for the robustness and user friendliness of CAN and CAN FD, in particular frame structure with identifier and arbitration according to the conventional CSMA/CR method, are adopted. The CSMA/CR method necessitates the existence of so-called recessive states on the bus 40 that may be overwritten by other subscriber stations 10, 20, 30 with dominant levels or dominant states on the bus 40.

With the two subscriber stations 10, 30, formation and then transmission of messages 45, 47 with various CAN formats, in particular the CAN FD format or the CAN SIC format or the CAN XL format, as well as the reception of such messages 45, 47 may be realized. This is described in more detail below for a message 45.

FIG. 2 shows a frame 450 for the message 45 which is in particular a CAN XL frame as provided by the communication controller 11 for the transmitting/receiving device 12 for transmission to the bus 40. In the present embodiment example, the communication controller 11 creates the frame 450 as compatible with CAN FD. Alternatively, the frame 450 is compatible with any successor standard for CAN FD.

According to FIG. 2, the frame 450 for CAN communication on the bus 40 is divided into different communication phases 451, 452, namely an arbitration phase 451 (first communication phase) and a data phase 452 (second communication phase). After a start bit SOF, the frame 450 has an arbitration field 453, a control field 454, a first switching field 455, a data field 456, a checksum field 457, a second switching field 458, and a frame termination field 459. The checksum field 457, the second switching field 458, and the frame termination field 459 form a frame end phase 457, 458, 459 of the frame 450.

In the arbitration phase 451, an identifier (ID) in the arbitration field 453 is used to negotiate between the subscriber stations 10, 20, 30 bit by bit which subscriber station 10, 20, 30 wishes to transmit the message 45, 46 with the highest priority and therefore gains exclusive access to the bus 40 of the bus system 1 for the near future for transmitting in the subsequent data phase 452. In the arbitration phase 451, a physical layer is used as in CAN and CAN FD. The physical layer corresponds to the bit transmission layer or layer 1 of the conventional OSI (Open Systems Interconnection) model.

A key point during phase 451 is the use of the conventional CSMA/CR method, which permits simultaneous access of the subscriber stations 10, 20, 30 to bus 40 without destroying the higher-priority message 45, 46. This makes it relatively easy to add further bus subscriber stations 10, 20, 30 to the bus system 1, which is very advantageous.

The CSMA/CR method necessitates the existence of so-called recessive states on the bus 40 that may be overwritten by other subscriber stations 10, 20, 30 with dominant levels or dominant states on the bus 40. In the recessive state, high-ohmic conditions prevail at the individual subscriber station 10, 20, 30, which in combination with the parasites of the bus circuitry results in longer time constants. This leads to a limitation of the maximum bit rate of the present-day CAN FD physical layer to currently approximately 2 megabits per second in real vehicle use.

At the end of the arbitration phase 451, switching into the data phase 452 takes place by means of the first switching field 455. This is described in further detail below.

In the data phase 452, in addition to a part of the first switching field 455, the payload data of the CAN XL frame 450 or of the message 45 from the data field 456, as well as the checksum field 457 and a part of the second switching field 458 are transmitted. In the checksum field 457, a checksum may be included of the data of the data phase 452 including the stuff bits. The stuff bits are inserted by the transmitter of the message 45 as an inverse bit after each of a predetermined number of bits with the same value (same bits), in particular 10 of the same bits. At the end of the data phase 452, switching back again into the arbitration phase 451 takes place by means of the second switching field 458.

At least one acknowledge bit may be included in an end field in the frame termination phase 459. A sequence of 11 identical bits may be present as well, which indicates the end of the CAN XL frame 450. The at least one acknowledge bit may be used to indicate whether or not a receiver has detected an error in the received CAN XL frame 450 or the message 45.

A transmitter of the message 45 does not start transmitting bits of the data phase 452 to the bus 40 until the subscriber station 10 as the transmitter has won the arbitration and the subscriber station 10 as the transmitter thus has exclusive access to the bus 40 of the bus system 1 for transmission.

Thus, in the arbitration phase 451 as the first communication phase, the subscriber stations 10, 30 partly, in particular up to (including) the FDF bit, use a format from CAN/CAN FD in accordance with ISO 11898-1:2015. In comparison to CAN or CAN FD, however, an increase in the net data transmission rate, in particular to more than 10 megabits per second, is possible in the data phase 452 as the second communication phase. It is also possible to increase the size of the payload data per frame, in particular to approximately 2 kbytes or any other value.

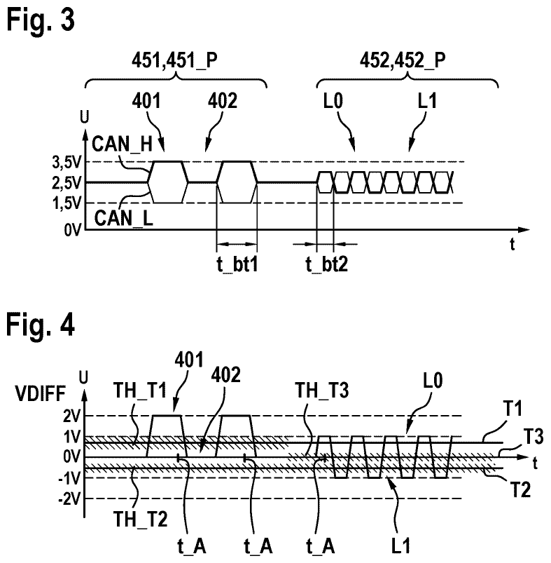

As shown in FIG. 3, in the arbitration phase 451, the transmitting/receiving devices 12 use a physical layer 451_P to transmit a transmission signal TxD (FIG. 1) over the time t as signals CAN_H, CAN_L to the bus 40. The same applies to the transmitting/receiving device 22. In contrast, in the data phase 452, the transmitting/receiving device 12 may use a physical layer 452_P, different from first physical layer 451_P, to transmit the transmission signal TxD (FIG. 1) as signals CAN_ H, CAN_L to the bus 40, as described above. For the physical layer 452_P, there are two operating modes, namely, FAST_TX and FAST_RX, as described in more detail below.

On the left side, FIG. 3 shows that the subscriber stations 10, 20, 30 in the arbitration phase 451 each transmit signals CAN_H, CAN_L over the time t to the bus 40, which signals have a first bit duration t_bt1. The signals CAN_H, CAN_L are serial signals and alternately have at least one dominant state 401, in which VCAN_H=3.5 V and VCAN_L=1.5 V, or at least one recessive state 402, in which VCAN_H=VCAN_L=2.5. In the case of NRZ encoding of the transmission signal TXD, dominant states 401 are driven in the phase 451 if TXD=0 or L (LOW). In the case of NRZ encoding of the transmission signal TXD, recessive states 402 are generated or arise in the phase 451 if TXD=1 or H (HIGH). After arbitration in the arbitration phase 451, one of the subscriber stations 10, 20, 30 is established the winner.

If the subscriber stations 10, 20, 30 detect the signal in the first switching field 455 of FIG. 3 to switch from the first to the second communication phase 451, 452, the respective transmitting/receiving device 12 switches its physical layer 451_P at the end of the arbitration phase 451 from a first operating mode (SLOW), which may also be implemented as an SIC operating mode, to the physical layer 452_P of the data phase 452. For this purpose, the operating modes of the data phase 452 are switched on as follows.

Assume that the first subscriber station 10 has won the arbitration. In this case, the transmitting/receiving device 12 of the subscriber station 10, in particular due to signaling in the first switching field 455 of FIG. 2, switches its physical layer 451_P at the end of the arbitration phase 451 from the first operating mode (SLOW) into the physical layer 452_P of the data phase 452 for a second operating mode (FAST_TX) of the transmitting/receiving device 12 since the subscriber station 10 is the transmitter of the message 45 in the data phase 452. As shown in FIG. 3, in the data phase 452 or in the second operating mode (FAST_TX), the transmission module 121 then generates, depending on a transmission signal TxD in succession and thus serially, the states L0 or L1 with the physical layer 452_P for the signals CAN_H, CAN_L on the bus 40. For a pulse width modulation (PWM encoding) of the transmission signal TXD, the state L0 (VCAN_H=3.0 V, VCAN_L=2.0 V) is driven in the transmission signal TXD for a first PWM symbol. For the pulse width modulation (PWM encoding) of the transmission signal TXD, the state L1 (VCAN_H=2, 0 V and VCAN_L=3, 0 V) is driven in the transmission signal TXD for a second PWM symbol which differs from the first PWM symbol.

The frequency of the signals CAN_H, CAN_L may be increased in the data phase 452. For this purpose, the bit time or bit duration t_bt2 in the data phase 452 in the example of FIG. 3 is shorter or less than the bit time or bit duration t_bt1 in the arbitration phase 451. The net data transmission rate in the data phase 452 in the example of FIG. 3 is thus increased in comparison to the arbitration phase 451.

By contrast, the transmitting/receiving device 12 of the subscriber station 30 switches its physical layer 451_P at the end of the arbitration phase 451 from the first operating mode (SLOW or SIC) into the physical layer 452_P of the data phase 452 for a third operating mode (FAST_RX) of the transmitting/receiving device 12 since the subscriber station 30 is only a receiver, and not a transmitter, of the frame 450 in the data phase 452.

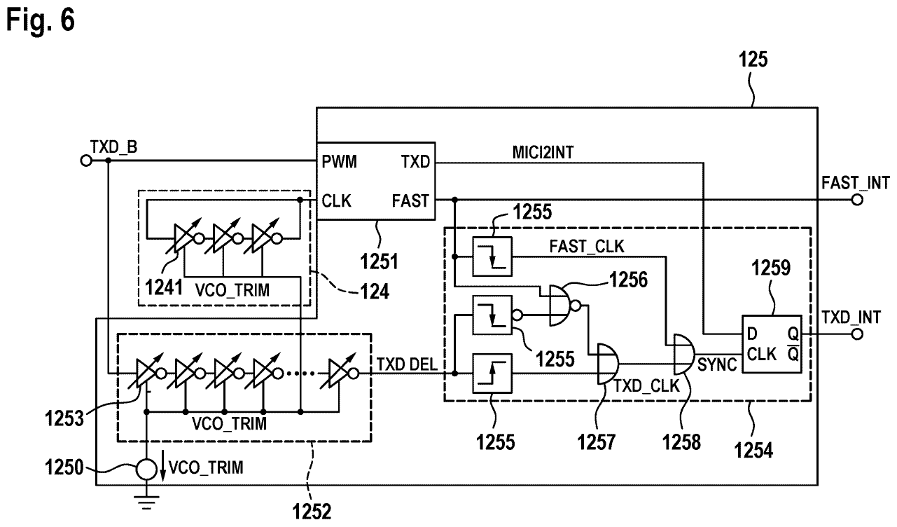

The profile of the corresponding signals in the transmitting/receiving device 12 when switching between the phases 451, 452 is explained in more detail below with reference to FIG. 6 to FIG. 17.

If the transmitting/receiving device 12 recognizes, in particular with the signaling in the second switching field 458 of FIG. 2, that switching from the data phase 452 back into the arbitration phase 451 is to be carried out, the transmitting/receiving device 12 is switched from transmitting (FAST_TX operating mode) (and) or receiving (FAST RX operating mode) signals with the physical layer 452_P to transmitting and/or receiving signals with the physical layer 451_P.

Accordingly, all of the transmitting/receiving devices 12 of the subscriber stations 10, 30 switch their operating mode to the first operating mode (SLOW SIC) after the end of the data phase 452. All transmitting/receiving devices 12 may thus not only switch between the bit durations t_bt1, t_bt2 but also switch their physical layer, as described above.

According to FIG. 4, a differential signal VDIFF=CAN_H−CAN_L with values of VDIFF=2 V for dominant states 401 and VDIFF=0V for recessive states 402 forms on the bus 40 in the ideal case in the arbitration phase 451 over the time t. The profile of VDIFF in the phase 451 is shown on the left side in FIG. 4. By contrast, a differential signal VDIFF=CAN_H−CAN_L corresponding to the states L0, L1 of FIG. 4 forms on the bus 40 in the data phase 452 over the time t, as shown on the right side in FIG. 4. The state L0 has a value VDIFF=1 V. The state L1 has a value VDIFF=−1 V.

The receiver module 122 may distinguish the states 401, 402, in each case using two of the receive thresholds T1, T2, T3 that lie in the ranges TH_T1, TH_T2, TH_T3. For this purpose, the receiver module 122 samples the signals of FIG. 3 or FIG. 4 at times t_A, as shown in FIG. 4. To evaluate the sampling result, in the arbitration phase 451, the receiver module 122 uses the receive threshold T1 of 0.7 V, for example, and the receive threshold T2 of −0.35 V, for example. In the data phase 452, on the other hand, the receiver module 122 only uses signals that were evaluated with the receive threshold T3. When switching between the first to third operating modes (SLOW or SIC, FAST_TX, FAST_RX) described above with reference to FIG. 3, the reception module 122 in each case switches the receive thresholds T2, T3.

The receive threshold T2 is used to detect whether the bus 40 is free when the subscriber station 12 is newly connected to the communication on the bus 40 and is attempting to integrate itself into the communication on the bus 40. Each subscriber station 10, 30 switches the operating mode of the transmitting/receiving device 12 to the operating mode of the arbitration phase 451 when the subscriber station 12 is (newly) connected to the communication on the bus 40 or attempts to integrate into the communication on the bus 40 once again after an error in the bus communication. In the cases mentioned, the subscriber station 10 may transmit data, in particular messages 45, 47, to the bus 40 only when it is detected that the bus 40 is free.

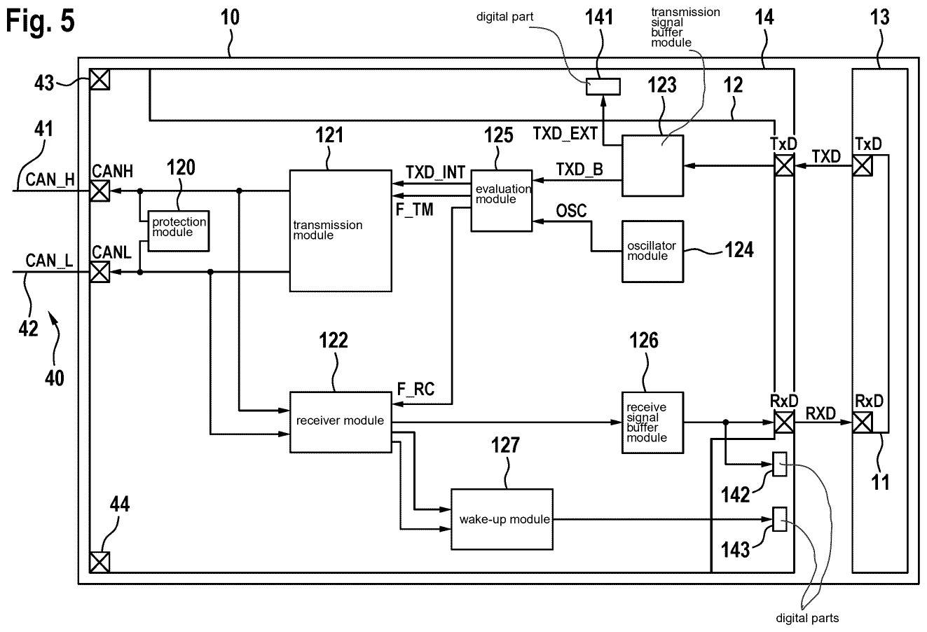

When the corresponding signals are received from the bus 40, each transmitting/receiving device 12 generates the associated receive signal RxD, as shown in FIG. 1 and FIG. 5. The receive signal RxD ideally does not have a time offset to the transmission signal TxD.

FIG. 5 shows the basic construction of the subscriber station 10 with its communication controller 11 and its transmitting/receiving device 12. The subscriber station 10 also has a microcontroller 13 and a system ASIC (ASIC=application-specific integrated circuit) 14. The system ASIC may be separate from the transmitting/receiving device 12 so that the transmitting/receiving device 12 is a separate device, which is also referred to as a stand-alone transceiver. The system ASIC 14 has digital parts 141, 142, 143, which may receive and evaluate signals from the transmitting/receiving device 12, in particular for diagnostic purposes, or may further process them.

The microcontroller 13 generates or processes data to be converted by the communication controller 11 into the corresponding frame format for transmitting messages 45, 47 via the bus 40.

The communication controller 11 may be designed as a protocol controller for transmitting and/or receiving CAN XL messages 45, 47. Optionally, the communication controller 11 is configured to transmit and/or receive CAN FD or CAN SIC messages 46. For transmitting the data to the bus 40, the communication controller 11 generates a transmission signal TXD according to the corresponding standard for CAN FD, CAN SIC or CAN XL messages 45, 47. At a port TxD, the device 11 outputs the transmission signal TXD to a port TxD of the transmitting/receiving device 12. The device 12 and the system ASIC 14 each have ports TxD and RxD.

The system ASIC 14 of the subscriber station 10 of FIG. 5 may alternatively be a system basis chip (SBC), which combines multiple functions necessary for an electronic assembly of the subscriber station 10. In addition to the transmitting/receiving device 12, an energy supply device (not shown), which supplies electrical power to the transmitting/receiving device 12 at a port 43, may be installed in the system ASIC 14. The energy supply device typically supplies a voltage CAN_Supply of 5 V. However, the energy supply device may supply a different voltage with a different value as needed. Additionally, or alternatively, the energy supply device is configured as a current source. A port 44 is used to connect to ground, also called CAN-GND.

In the example of FIG. 5, in addition to the transmission module 121 and the reception module 122, the transmitting/receiving device 12 also has a protection module 120, a transmission signal buffer module 123, an oscillator module 124, a transmission signal evaluation module 125, a receive signal buffer module 126, and a wake-up module 127. FIG. 5 shows the modules 121 to 127 only in a simplified manner. The transmission signal evaluation module 125 is also hereinafter referred to as the evaluation module 125.

The protection module 120 is connected to the bus wires 41, 42 and serves to protect the transmitting/receiving device 12 from electrostatic discharge (ESD).

A transmission signal TXD received from the device 11 is temporarily stored in the transmission signal buffer module 123. In the case of CAN XL, the transmission signal TXD at the port TxD of the device 11 is a transmission signal that is pulse-width-modulated at least temporarily or in sections, as mentioned above with reference to FIG. 3. The transmission signal buffer module 123 outputs a transmission signal TXD_EXT to the digital part 141 and a transmission signal TXD_B to the evaluation module 125. The evaluation module 125 also receives an oscillator signal OSC with a predetermined frequency f from the oscillator module 124.

The evaluation module 125 is configured to forward and/or process the transmission signal TXD_B using the oscillator signal OSC. In the first communication phase 451 of a message 45, in which the transmission signal TXD is not pulse-width-modulated (PWM), the evaluation module 125 forwards the transmission signal TXD_B unchanged to the transmission module 121. In the second communication phase 452 of the message 45, in which the transmission signal TXD is pulse-width-modulated (PWM), the evaluation module 125 carries out a pulse width demodulation of the transmission signal TXD_B. The transmission signal TXD_INT output by the evaluation module 125 to the transmission module 121 is thus a decoded or pulse-width-demodulated transmission signal. In addition, the evaluation module 125 outputs a signal F_TM to the transmission module 121 and a signal F_RC to the reception module 122. The signals F_TM, F_RC signal or indicate which physical layer the modules 121, 122 are to switch on, in particular whether the physical layer 452_P (FIG. 3) is to be switched on for the data phase 452 or not.

The transmission module 121 is configured to convert the transmission signal TXD_INT of the evaluation module 125 into the signals CAN_H, CAN_L for the bus 40, as described above with reference to FIG. 3 and FIG. 4. The transmission module 121 is connected via ports CANH, CANL for the bus wires 41, 42 directly to the bus 40 in order to transmit analog signals CAN_H, CAN_L based on the transmission signal TXD_INT, to the bus 40.

The signals and functions for transmitting the transmission signal TXD to the bus 40 are explained in more detail with reference to FIG. 6 to FIG. 17.

According to FIG. 5, the reception module 122 is also directly connected to the bus 40 via the ports CANH, CANL for the bus wires 41, 42. The receiver module 122 is configured for generating the digital receive signal RXD from the signals CAN_H, CAN_L received from the bus 40 at the ports CANH, CANL. The receiver module 122 transmits or forwards the receive signal RXD to the receive signal buffer module 126. In addition, the receiver module 122 forwards the signals CAN_H, CAN_L to the wake-up module 127. The wake-up module 127 may also use the digital part 143 to determine whether the communication controller 11 should be woken up again after it has been put to sleep, for example in order to save energy.

The receive signal buffer module 126 outputs the receive signal RXD via the port RxD of the system ASIC 14 or of the transmitting/receiving device 12 to the port RxD of the microcontroller 13 or of the communication controller 11. In addition, the receive signal buffer module 126 forwards the receive signal RXD to the digital part 142.

FIG. 6 shows the design of the evaluation module 125 of FIG. 5 in more detail, which is connected to the oscillator module 124 of FIG. 5 as is also shown in FIG. 6. The evaluation module 125 has a current sink 1250 which conducts a current VCO_TRIM to ground, in particular CAN_GND, an MICI block 1251, a delay block 1252, and a synchronization block 1254.

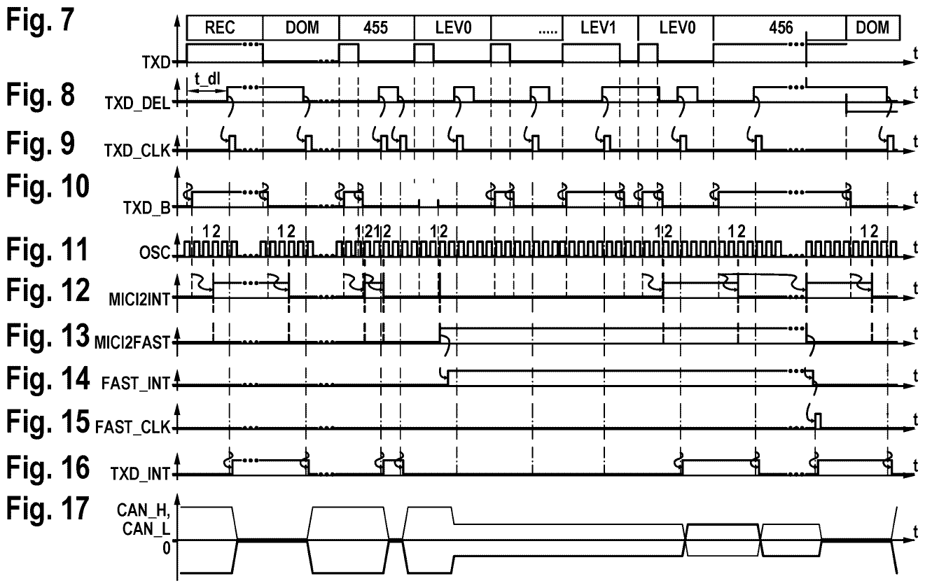

FIG. 7 to FIG. 17 show, for an area before and until after the switching field 455 of a frame 450 of FIG. 2, the following signals that occur during operation of the device 12 and in particular of the modules 124, 125 of FIG. 5 and FIG. 6.

According to FIG. 6, the MICI block 1251 has an input PWM for the transmission signal TXD (FIG. 7) and TXD_B (FIG. 10) and an input CLK for the clock signal OSC (FIG. 11) of the oscillator module 124. In addition, the MICI block 1251 has an output TXD for outputting a signal MICI2INT (FIG. 12) and an output FAST for outputting a signal FAST_INT (FIG. 14). The signal FAST_INT results from the signal MICI2FAST (FIG. 13) and is used for generating the signals F_TM and F_RC of FIG. 5.

The MICI block 1251 is configured to detect the type of data encoding on the TxD port or in the transmission signal TXD (FIG. 7). For this purpose, the MICI block 1251 receives the signal TXD B (FIG. 10) forwarded by the transmission signal memory module 123 (FIG. 5). The MICI block 1251 detects the PWM encoding in the switching field 455 (FIG. 2), as shown in FIG. 10 taken into account with FIG. 7, when two successive edges of the same polarity occur within a predetermined period of time, which is in particular 205 ns, in the signal TXD and TXD_B (FIG. 10). If the PWM encoding is detected or present, the MICI block 1251 signals the transmission module 121 the fast operating mode (FAST mode) with the signal FAST_INT or F_TM (FIG. 5), as follows.

If the MICI block 1251 detects two rising edges per PWM symbol in the switching field 454 in the signal TXD_B or TXD (FIG. 5), the MICI block 1251 generates the signal FAST_INT such that the transmission module 121 as the transmitting node is signaled to switch to the fast operating mode (FAST mode), i.e., to the second operating mode FAST_TX. However, if the MICI block 1251 detects two falling edges per PWM symbol in the switching field 455 in the signal TXD_B or TXD (FIG. 5), the MICI block 1251 generates the signal FAST_INT such that the transmission module 121 as the receiving node is signaled to switch to the fast operating mode (FAST mode), i.e., to the third operating mode FAST_RX.

A distinction is made in the FAST operating modes FAST_TX, FAST_RX between the two TXD symbols Level0 (PWM duty cycle<50%) and Level1 (PWM duty cycle>50%). The TXD symbol Level0 is referred to in FIG. 7 as LEVO and in FIG. 19 to FIG. 21 as L0.

The TXD symbol Level1 is referred to in FIG. 7 as LEV1 and in FIG. 19 to FIG. 21 as L1. As soon as the PWM encoding according to CiA610-3 transitions into an NRZ encoding, in which the specified time window does not contain two consecutive edges of the same direction, the MICI block 1251 again signals, with the signal FAST_INT (FIG. 6) or F_TM (FIG. 5), the switch into the SLOW operating mode to the transmission module 121. As a result, the transmission module 121 (FIG. 5) converts the signal TXD_B or TXD again into the recessive or dominant bus voltage, as described above with reference to FIG. 3 and FIG. 4.

According to FIG. 6, the transmission signal TXD or TXD_B is passed directly to the MICI block 1251 and to the delay block 1252 to output a delayed transmission signal TXD_DEL, the time profile of which is shown in FIG. 8. The MICI block 1251 is clocked by the, in particular, internal, oscillator block 124 based on delay cells 1241, for example, at a frequency VCO=300 MHz. The oscillator block 124 is a ring oscillator, for example. The clock domain of the oscillator block 124 and the clock domain of the MICI block 1251 are not synchronous to the data stream at the port for the transmission signal TXD and TXD_B, which is shown in FIG. 7 and FIG. 10. Therefore, the decoded signals at the output of the MICI block 1251 (FAST_INT and MICI2INT) are not synchronous to the data stream at the port for the transmission signal TXD and TXD_B, as shown in FIG. 7 to FIG. 13. As a result, the sampling of the data stream by the MICI block 1251 with the internal clock may misrepresent the bit lengths of the data of the transmission signal TXD and TXD_B with the length t_bt1 or t_bt2 synchronously with the internal clock by a maximum of one clock length, i.e., with an internal bit length t_bt +/−1CLK. Bit length fluctuations (jitter) of +/−1CLK thus result. The resulting bit length distortion would be passed on to the transmission module 121 without the circuit of FIG. 6 and would result in a concept-immanent bit length distortion of a maximum of +/−1CLK.

Thus, without the circuit of FIG. 6 at an oscillator frequency VCO of, for example, 250 MHz, a bit length distortion of a maximum +/−4 ns would result. For example, at an oscillator frequency VCO of 300 MHz, there would be a bit length distortion of +/−3.33 ns maximum without the circuit of FIG. 6. For example, at an oscillator frequency VCO of 500 MHz, there would be a bit length distortion of +/−2 ns maximum without the circuit of FIG. 6.

Since the asymmetry of the bit lengths with a few nanoseconds, in particular +/−5 ns or +/−7.5 ns, is a very critical and bit rate restricting parameter of the CAN-XL architecture, the blocks 1252 and 1254 are present and configured as described below. The blocks 1252, 1254 provide a significant reduction or minimization of the bit length distortion and avoid the otherwise required high circuitry cost to compensate for process fluctuations and/or voltage and temperature variations.

The delay block 1252 has a delay sequence of delay cells 1253 which form replicas of the delay cells 1241 and are thus structured identically to the delay cells 1241. The delay block 1252 generates a delayed transmission signal TXD_DEL that is a synchronous mapping of the TXD signal to the data stream at the port for the transmission signal TXD and/or TXD_B, but is delayed by a corresponding number of clock cycles. The corresponding number of clock cycles corresponds to a delay time t_dl shown in FIG. 8.

If, for example, the MICI block 1251 requires three rising edges for the evaluation in the switching field 455, the delay sequence consisting of delay cells 1253>3CLK or 3 cycles should be selected. In this case, the clock duration of the delay sequence of delay cells 1253 must be a multiple of the clock duration of the oscillator block 124 and fit (match) very well, in particular, have the same structure. For example, if the oscillator block 124 has 3 inverters, as shown in FIG. 6 as an example, then a period 2+3=6 inverter times are required. If the delay block 1252 is to generate a delay of 3 cycles, 3*6=18 inverter times or a sequence consisting of 18 inverters as delay cells 1253 is required. Only a portion of the inverter/delay cells 1253 are shown in FIG. 6 for this example. According to FIG. 6, the output of the MICI block 1251, more specifically the signal MICI2INT, and the signal TXD DEL of the block 1252 are input into the synchronization block 1254.

The synchronization block 1254 has three edge detectors 1255, a NOR gate 1256, an OR gate 1257, an OR gate 1258, and a D-flip flop 1259. The NOR gate 1256, OR gate 1257, OR gate 1258, and D-flip flop 1259 form a logic circuit 1256 . . . 1259.

One of the edge detectors 1255 is connected to the FAST output of the MICI block 1251 and detects falling edges in the signal FAST_INT. In two inputs 1255, the transmission signal TXD_DEL delayed by the delay block 1252 is input, wherein one of the two inputs 1255 detects falling edges in the signal TXD_DEL, and wherein the other of the two inputs 1255 detects rising edges in the signal TXD_DEL.

The output of the MICI block 1251, more specifically the signal MICI2INT, is clocked into the D-flip flop 1259 with the synchronization block 1254 synchronously with the data stream of the signal TXD_DEL. The resulting signal TXD_INT is forwarded to the transmission module 121 (FIG. 5).

The synchronization cycle (SYNC) on the D-flip flop 1259 of FIG. 6 is formed by three events as seen in FIG. 6.
1st event: Each rising edge of the transmission signal TXD_INT (edge detector on rising edges) clocks the synchronization D-flip flop 1259 of the TXD_INT signaling.
2nd event: If the MICI block 1251 is not switched to the fast operating mode (FAST mode), because the output FAST=0, each falling edge of TXD_INT also clocks the D-flip flop 1259.
3rd event: If the fast operating mode (FAST mode) is exited, the falling edge on FAST_INT also triggers a synchronization on the D-flip flop 1259.

The blocks 1252 and 1254 avoid the concept-related additional bit distortion (jitter) of +/−1CLK of the MICI block 1251 by synchronizing the output of the MICI block 1251 again to the data stream of the transmission signal TXD or TXD B. This is particularly important because using the MICI block 1251 without blocks 1252 and 1254 for the recessive dominant transitions would also cause additional distortion of +/−1CLK in the arbitration phase 451. In the arbitration phase 451, the maximum allowed asymmetry with +/−10 ns is somewhat greater than in CAN-XL fast operation in the data phase 452. However, due to the asymmetric signaling (2V and 0V) and the edge steepness and supply voltage dependent definition of the dominant and recessive states (recessive if VDIFF f<500 mV, dominant if VDIFF>900 mV), it is also very difficult to achieve. Synchronization with the blocks 1252 and 1254 is carried out by the delay sequence, which is made from replicas of the delay cells of the (ring) oscillator and controlled with the trimmed voltage of the oscillator (e.g., trimming voltage of a voltage controlled oscillator, VCO). Thereby, a defined delay corresponding to the clock frequency is given, which is synchronous to the data stream of the transmission signal TXD and TXD B and forwards the output of the MICI block 1251 synchronously with the data stream to the transmission module 121, i.e., without the jitter of +/−1CLK.

Thus, it is possible that the transmission module 121 is always controlled via the evaluation module 125, i.e., in normal operation (dominant recessive in at least the first communication phase 451) and in a FAST operating mode (L0, L1 in the second communication phase 452 of CAN XL). Clean signaling on the transmission module 121 and therefore clear transitions when entering and exiting the FAST operating mode of CAN XL are thus guaranteed.

FIG. 17 shows the signals CAN_H, CAN_L, which are transmitted to the bus as a result of the circuit of FIG. 5 and FIG. 6. Accordingly, the signals CAN_H, CAN_L do not contain incomplete transitions from dominant to recessive, so that the signals CAN_H, CAN_L are error free. In addition, with the evaluation module 125 of FIG. 6, there is a fluctuation-free or jitter-free signaling for switching to the data phase 452 of a CAN_XL frame 450 of FIG. 2.

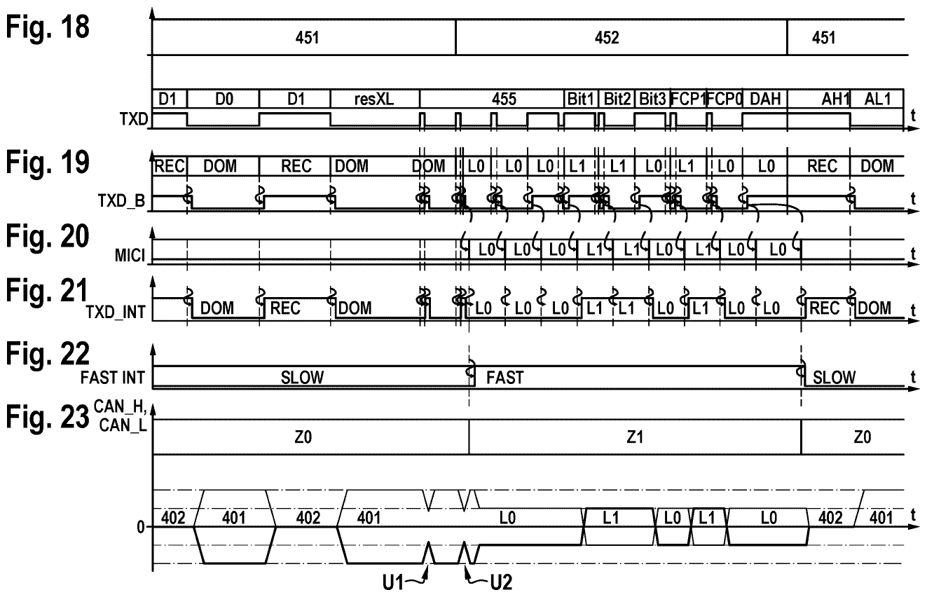

FIG. 18 to FIG. 23, on the other hand, show the use case over time t in which the MICI block 125 is used without the blocks 1252, 1254, and in addition, the MICI block 125 is only used in the second communication phase 452 of CAN XL. In this respect, FIG. 18 shows both the sequence of communication phases 451, 452, 451, based on which the operating modes (SLOW, FAST) of the transmission module 121 are to be switched, as described above, as well as the bit stream and the signaling to the port TxD of the device 12 as well as the corresponding encoding of the associated transmission signal TXD to the device 12. FIG. 19 shows the intended decoded transmission signal TXD for the states dom rec, and/or 401, 402 or L0, L1, and the associated signal TXD_B, to be driven by the transmission module 121 to the bus 40. FIG. 20 shows the signal decoded and output by the MICI block 125. FIG. 21 shows the signal TXD_INT incoming at the input of the transmission module 121. FIG. 22 shows the signal FAST_INT for the signals F_TM and F_RC, as described above. FIG. 23 shows the profile of the resulting signals CAN_H, CAN_L for the states Z0 (MICI block 125 not active), Z1 (MICI block 125 active).

Compared to the signal of FIG. 17, in FIG. 23 the two incomplete and short transitions U1, U2 from dominant (401) to recessive (402) are present in the profile of the bus signals CAN_H, CAN_L on the bus 40 in the switchover phase (cf. switching field 455 in FIG. 18).

Therefore, the evaluation module 125 is employed to avoid these undesired transitions U1, U2 of FIG. 23, as described above in relation to FIG. 5 to FIG. 17.

Thus, the evaluation module 125 of FIG. 5 and FIG. 6 may entirely avoid the second short dominant-recessive transition U2 (FIG. 23) when detecting the FAST operating mode of CAN XL. In addition, the evaluation module 125 may also largely avoid the first short dominant-recessive-dominant transition U1 (FIG. 23) at the first PWM symbol after the arbitration phase 451 with a correspondingly short PWM symbol, since the decoding of each TXD transition by the MICI block 1251 thus causes a delay of the internal TXD signal (TXD_INT1 as input to transmission module 121) which, for example, lasts 3 clock cycles, or approx. 10 ns. If a falling edge of the transmission signal TXD appears in this time window, no edge is forwarded to the transmission signal TXD_INT so that the evaluation module 125 also avoids the first drop (transition Ul in FIG. 23) in the signals CAN_H, CAN_L on bus 40. If the first PWM pulse lasts longer than approximately 10 ns, the evaluation module 125 forwards a correspondingly shortened pulse at its output in the signal TXD_INT due to the function of block 1254 described above.

Thus, the MICI block 1251 is responsible for both the dominant-recessive transitions of the first communication phase 451 and the LO-LI transitions of the second communication phase 452, as well as for the change between the SLOW, FAST_TX, FAST_RX operating modes. This guarantees signaling on bus 40 according to FIG. 17, which has little system impact and operates in a low-emission manner.

In addition, the switching of the transmission module 121 (transmitter) is always synchronous to the data stream of the transmission signal TXD. Thus, an asymmetry present in the related art is improved by approximately +/−3 ns when operating the subscriber stations 10, 30 for CAN-XL.

All above-described configurations of the evaluation module 125, the transmitting/receiving device 12, the subscriber stations 10, 20, 30, the bus system 1, and the method carried out therein, according to the embodiment examples and their modifications may be used individually or in all possible combinations. In particular, the following modifications are possible as well.

The above-described bus system 1 according to one of the embodiment examples is described with reference to a bus system based on the CAN protocol. However, the bus system 1 according to at least one of the embodiment examples may alternatively be another type of communication network in which the signals are transmitted as differential signals. It is advantageous, but not necessarily a prerequisite, that exclusive, collision-free access of a subscriber station 10, 20, 30 to the bus 40 is ensured in the bus system 1 at least for certain periods of time.

The bus system 1 according to at least one of the embodiment examples and their modifications is in particular a bus system in which communication between at least two of the subscriber stations 10, 20, 30 may take p ace according to two different CAN standards, for example CAN_HS or CAN FD or CAN SIC or CAN XL. However, the bus system 1 may be another communication network in which the signals are transmitted as differential signals and serially via the bus 40. The functionality of the above-described embodiment examples may thus be used, for example, with transmitting/receiving devices 12, 22 that are to be operated in such a bus system.

The number and arrangement of the subscriber stations 10, 20, 30 in the bus system 1 according to at least one of the embodiment examples and their modifications is freely selectable.

1-14. (canceled)

15. A transmission signal evaluation module for a transmitting/receiving device of a subscriber station of a serial bus system, wherein a transmission module is configured to transmit a digital transmission signal as an analog differential signal on a bus of the bus system to transmit a message to at least one other subscriber station of the bus system, wherein bits of the digital transmission signal have a greater bit duration in a first communication phase than in a second communication phase of the transmission signal, wherein the transmission signal evaluation module comprises:
an MICI block configured to decode a first transmission signal generated by a communication controller of the subscriber station, and to generate, from the first transmission signal, a decoded transmission signal and a mode of operation switch signal, with which the transmission module is to be signaled to switch to predetermined operating modes for the first and second communication phases, to generate the analog differential signal for the bus;
a delay block configured to generate a delayed transmission signal from the first transmission signal; and
a synchronization block configured the digital transmission signal for the transmission module from the decoded transmission signal and the delayed transmission signal.

16. The transmission signal evaluation module according to claim 15, wherein the delay block includes a delay sequence of delay cells forming replicas of delay cells of an oscillator module connected to the MICI block for clocking the decoding of the MICI block.

17. The transmission signal evaluation module according to claim 16, wherein the delayed transmission signal is delayed by a predetermined number of cycles of a clock of the oscillator module as compared to the first transmission signal.

18. The transmission signal evaluation module according to claim 16, wherein the synchronization block includes:
an edge detector configured to detect falling edges of the first transmission signal,
an edge detector configured to detect falling edges of the delayed transmission signal,
an edge detector configured to detect rising edges of the delayed transmission signal, and
a logic circuit configured to generate the digital transmission signal for the transmission module based on signals output by the edge detectors.

19. The transmission signal evaluation module according to claim 18, wherein the synchronization block also includes a D-flip flop configured to generate the digital transmission signal for the transmission module based on the signals output by the edge detectors.

20. The transmission signal evaluation module according to claim 15, wherein the MICI block is configured to decode a temporarily NRZ-encoded first transmission signal and decode pulse-width modulated symbols of the temporarily pulse-width modulated first transmission signal.

21. The transmission signal evaluation module according to claim 15, wherein the MICI block is configured to decode the first transmission signal in the first communication phase and to decode the first transmission signal in the second communication phase.

22. The transmission signal evaluation module according to claim 15, wherein:
the MICI block is configured to decode signals in the first transmission signal for three different operating modes of the transmission module, and
the MICI block is configured to generate the operating mode switch signal based on the decoding such that the transmission module is signaled to use a first operating mode for the first communication phase, a second operating mode when the subscriber station is to act as the transmitter in the second communication phase, and a third operating mode when the subscriber station is to act as the receiver in the second communication phase.

23. A transmitting/receiving device for a subscriber station of a serial bus system, comprising:
a transmission module configured to transmit a digital transmission signal as an analog differential signal to a bus of the bus system to transmit a message to at least one other subscriber station of the bus system, wherein bits of the digital transmission signal have a greater bit duration in a first communication phase than in a second communication phase of the transmission signal;
a receiver module configured to receive signals from the bus and to generate a digital receive signal from the analog differential signal; and
a transmission signal evaluation module including:
an MICI block configured to decode a first transmission signal generated by a communication controller of the subscriber station, and to generate, from the first transmission signal, a decoded transmission signal and a mode of operation switch signal, with which the transmission module is to be signaled to switch to predetermined operating modes for the first and second communication phases, to generate the analog differential signal for the bus,
a delay block configured to generate a delayed transmission signal from
the first transmission signal, and a synchronization block configured the digital transmission signal for the transmission module from the decoded transmission signal and the delayed transmission signal.

24. The transmitting/receiving device according to claim 23, wherein the MICI block is configured to decode the message in the first communication phase and decode the message in the second communication phase.

25. The transmitting/receiving device according to claim 23, wherein the transmission module is configured to generate the analog differential signals with a different physical layer in the first communication phase of the message than in the second communication phase.

26. A subscriber station for a serial bus system, the subscriber station comprising:
a transmitting/receiving device, including:
a transmission module configured to transmit a digital transmission signal as an analog differential signal to a bus of the bus system to transmit a message to at least one other subscriber station of the bus system, wherein bits of the digital transmission signal have a greater bit duration in a first communication phase than in a second communication phase of the transmission signal;
a receiver module configured to receive signals from the bus and to generate a digital receive signal from the analog differential signal; and
a transmission signal evaluation module including:
an MICI block configured to decode a first transmission signal generated by a communication controller of the subscriber station, and to generate, from the first transmission signal, a decoded transmission signal and a mode of operation switch signal, with which the transmission module is to be signaled to switch to predetermined operating modes for the first and second communication phases, to generate the analog differential signal for the bus,
a delay block configured to generate a delayed transmission signal from the first transmission signal, and
a synchronization block configured the digital transmission signal for the transmission module from the decoded transmission signal and the delayed transmission signal; and
a communication controller configured to control communication in the bus system and to generate the first transmission signal.

27. The subscriber station according to claim 26, the bus system is a bus system in which exclusive, collision-free access of a subscriber station to the bus of the bus system is ensured at least temporarily.

28. A method for transmitting a message with differential signals in a serial bus system, wherein the method is carried out with a transmitting/receiving device including a transmission module, and a transmission signal evaluation module which includes an MICI block, a delay block, and a synchronization block, the method comprising the following steps:
decoding, using the MICI block, a first transmission signal generated by a communication controller of the subscriber station for the message in which bits in a first communication phase of the message have a greater bit duration than in a second communication phase of the message;
generating, using the MICI block from the first transmission signal, a decoded transmission signal and an operating mode switch signal with which the transmission module is signaled to switch to predetermined operating modes for two different communication phases in order to generate the analog differential signal for the bus;
generating, using the delay block, a delayed transmission signal from the first transmission signal;
generating, using the synchronization block, a digital transmission signal for the transmission module from the decoded transmission signal and the delayed transmission signal; and
transmitting, using the transmission module which is switched to the predetermined operating mode signaled with the mode of operation signal, the digital transmission signal as an analog differential signal on a bus of the bus system to transmit the message to at least one other subscriber station of the bus system.
